(19) United States
(12) Patent Application Publication
(10) Pub. No.: US 2007/0295180 A1
(43) Pub. Date: Dec. 27, 2007

(54) Cutting Strip

(75) Inventors: Joerg Schmeiser, Wiggensbach (DE); Ralf-Peter Mueller, Kempten (DE)

Correspondence Address: FOLEY & LARDNER LLP, 777 EAST WISCONSIN AVENUE, MILWAUKEE, WI, 53202-5306, US

(73) Assignee: CFS KEMPTEN GMBH, 87437Kempten (DE)

(21) Appl. No.: 11/631,881

(22) PCT Filed: Jul. 11, 2005
(86) PCT No.: PCT/EP05/07504

§ 371 Date: Aug. 30, 2007

(30) Foreign Application Priority Data
Jul. 9, 2004 (DE) 10 2004 033 568.0

(51) Int. Cl. B26D 1/143

(52) U.S. Cl. 83/401

(57) ABSTRACT

The invention relates to a device for slicing foodstuffs, in particular ham, sausage, bacon, cheese or similar. Said device comprises a housing with a product feed unit, on the end of which a cutting strip is situated. The strip comprises a cutting edge and a blade that is driven in a rotative or planetary manner. A cutting gap is configured between the cutting edge and the blade.

The present invention relates to a device for slicing foodstuffs, in particular ham, sausage, bacon, cheese or similar, comprising a machine housing with a product feed unit attached thereto, at the end of which a cutting strip is arranged, which cutting strip exhibits a cutting edge, and having a blade that is driven in a rotative and/or planetary rotating manner, a cutting gap being present between the cutting edge and the blade.

In devices of this kind, which are customarily referred to as slicers, the size of the cutting gap between the blade and the cutting edge has a determining influence on the cutting result and thus on the quality of the cut slice. On the one hand excessively large cutting gaps lead to the effect of so-called “beard formation” on the product, and on the other hand an excessively small cutting gap often led to contact between the blade and the cutting edge, which in turn can lead to the destruction of or increased wear in both components. Accordingly, there has been no lack of attempts to adjust the cutting gap as accurately as possible by means of the cutting edge. As a rule, this adjustment takes place through a linear displacement of the cutting strip as parallel as possible to the blade, although this is only successful at very high cost and as a rule is not reproducible.

The object of the present invention was thus to make available a device which does not exhibit the disadvantages associated with the prior art.

It was extremely astonishing and unexpected to a person skilled in the art that it is possible with the device according to the invention to adjust the cutting gap in a reproducible manner and with very high accuracy. The device according to the invention is simple and economical to manufacture and to operate. In the lower area in particular, the cutting edge is adjustable with very great accuracy. The torsion-dependent deviations in the parallelism of the cutting strip from the cutting edge are minimal and are negligible as such. The adjustment about a pivot point can be achieved considerably more easily and more hygienically by mechanical means than the parallel displacement of the cutting strip. Adjustment of the cutting strip can take place both manually and automatically before or during operation. The desired position of the cutting edge in each case can be entered in the machine program and set reproducibly.

According to the invention, the cutting strip exhibits a pivot point, about which it is preferably capable of being caused to pivot and/or to flex so that the cutting gap becomes larger or smaller.

The pivot point for the cutting strip is preferably arranged above the cutting edge. This embodiment of the present invention has the advantage that the cutting gap, in particular in its lower area, is capable of highly accurate adjustment, and that the deviation in the parallelism of the cutting strip from the cutting plane is minimal at that point. A quite particular preference exists for the pivot point to be arranged, if at all possible, in or as close to the cutting plane, which in turn causes the smallest possible deviation in parallelism from the cutting edge.

The pivot point can be realized in any desired manner that is familiar to a person skilled in the art, although the pivot point is preferably a pivot bearing. A quite particular preference exists for the pivot point to be an axis, which is arranged parallel to the blade and the cutting plane, and on which the cutting strip is pivotably mounted with a pivot bearing. A quite particular preference exists for this pivot bearing to be of two-part execution, so that it is readily removable, for example.

In one quite particularly preferred embodiment, the cutting strip is capable of displacement along the pivot axis parallel to the cutting plane. This embodiment is especially advantageous when the cutting strip is configured as a component part of a mouth piece, so that the products are supported not only vertically, but also laterally, by the cutting strip. It is thus possible for the position of the product to be influenced by the lateral displacement of the cutting strip during cutting and also after cutting. Incidentally, reference is made to the disclosure of the patent application under reference 10 2004 120.3 of the German Patent Office, which is accordingly adopted as a reference and thus qualifies as a part of the disclosure.

In a preferred embodiment of the device according to the invention, the cutting strip is pretensioned at least partially in the direction of the blade with a spring means. A particular preference exists in this case for the blade to contact the cutting edge oh each passage of the blade and, in so doing, to deflect the cutting strip lightly against the pretension. This preferred embodiment of the device according to the invention has the advantage that the cutting gap is reduced at least partially to zero.

A particular preference exists, in conjunction with the arrangement with a spring, for the additional use of a damping element, which severely restricts the speed of movement of the cutting strip in the direction of the blade, so that the cutting strip, once contact with the blade has ended, moves only slowly in the direction of the blade. As a result, the blade is only required to push back the cutting strip over a small distance, for example 0.05 mm.

In this case, the movement of the cutting strip in the opposite direction (away from the blade) is influenced either not at all or only to a small extent. This speed control can be implemented, for example, via a hydraulic element consisting of a displacement cylinder, a throttle and a free-wheel valve.

The cutting strip and thus the cutting edge are preferably part of the mouth piece of a slicing device, by means of which the one or more pieces of foodstuff is/are held during slicing.

The cutting strip, in particular when it also serves as a mouth piece for the one or more pieces of foodstuff to be sliced, is preferably supported parallel to the cutting gap in such a way as to be capable of displacement, so that the one or more pieces of foodstuff can be varied in its/their position relative to the blade.

The cutting strip is preferably caused to pivot or to flex with a means, preferably an eccentric, located at a distance from the pivot point. It is preferably sufficient, in conjunction with this, to set the smallest possible deflections about the cutting gap accordingly, which cutting gap is varied in a maximum range of +/−0.5 mm. Adjustment of the means can be effected both automatically or manually.

Automatic adjustment preferably takes place with a regulated drive, for example a servomotor, and in particular preferably before or during operation of the device. The use of a servomotor, which transmits a signal indicating its actual position, for example to a central control unit, has the advantage that the position of the cutting strip at any given time is known.

Automatic adjustment of the cutting strip has the advantage that the size of the desired cutting gap selected in each case for the product in question is capable of being entered into a machine program and set reproducibly. Setting in this case can take place during operation, and repeated verification of whether the cutting gap still exhibits the correct size is possible. In the event of wear in the blade and/or the cutting strip, resetting of the cutting gap is also possible during operation. Furthermore, it is possible to compensate for changes to the cutting gap, for example arising from heating of the blade and from speed-dependent and/or temperature-dependent expansion phenomena of the blade.

The size of the cutting gap can be measured optically, for example, or with some other sensor. Alternatively, it is also possible to continue to reduce the cutting gap with the adjusting means until the cutting edge touches the blade, and then to move the cutting edge away by a predetermined amount, which corresponds to the desired cutting gap. Contact with the blade can be established with a contact sensor acoustically and/or through the current consumption of the servomotor.

This setting can be repeated as often as desired during operation of the blade.

The cutting gap is preferably set and/or varied via a machine display.

A further object of the present invention is a method for the adjustment of the cutting gap between the blade and the cutting edge of a cutting strip in a foodstuffs slicing machine, in which the cutting strip is caused to pivot and/or flex about a pivot point.

The method is simple and economical to implement.

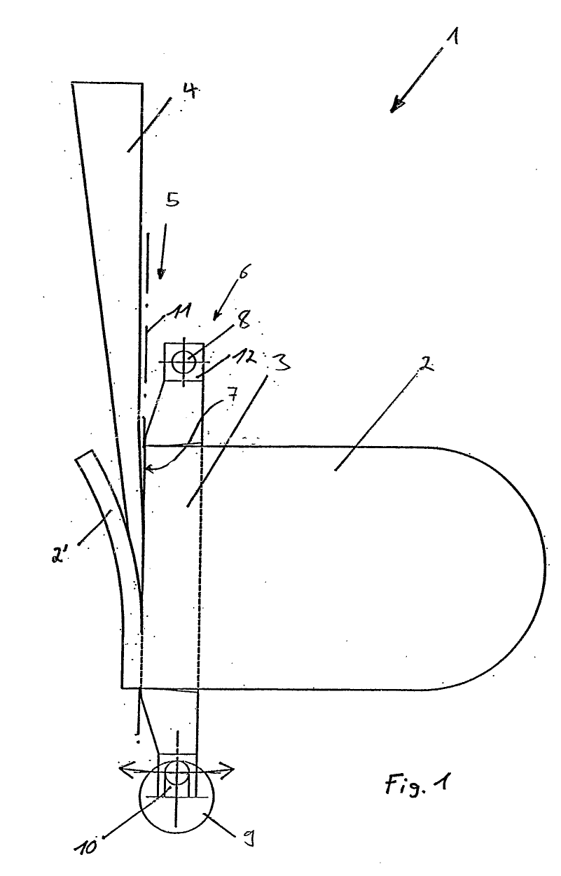

The invention is explained below with reference to FIGS. 1 to 3. These explanations are provided by way of example only and do not restrict the general idea of the invention.

FIG. 1 depicts an embodiment of the device according to the invention.

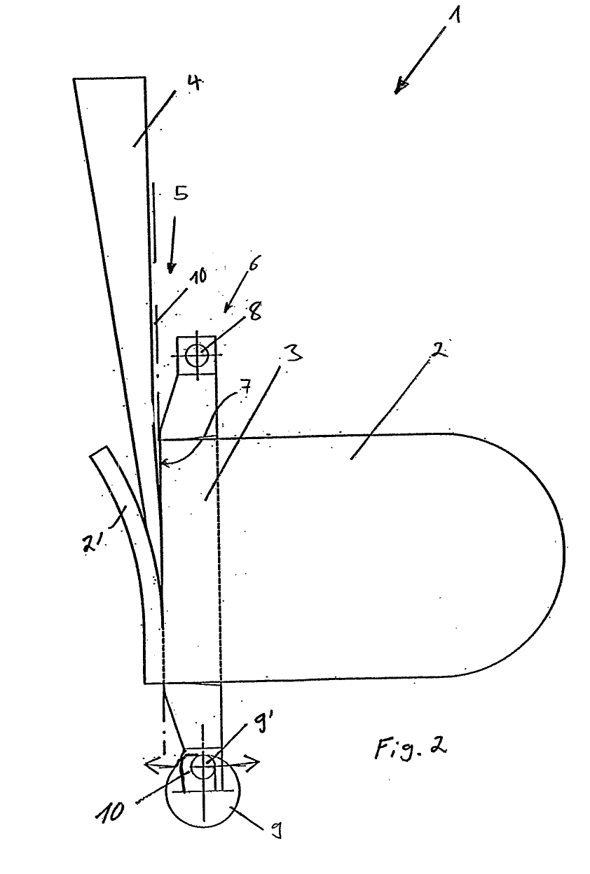

FIG. 2 depicts a further embodiment of the device according to the invention.

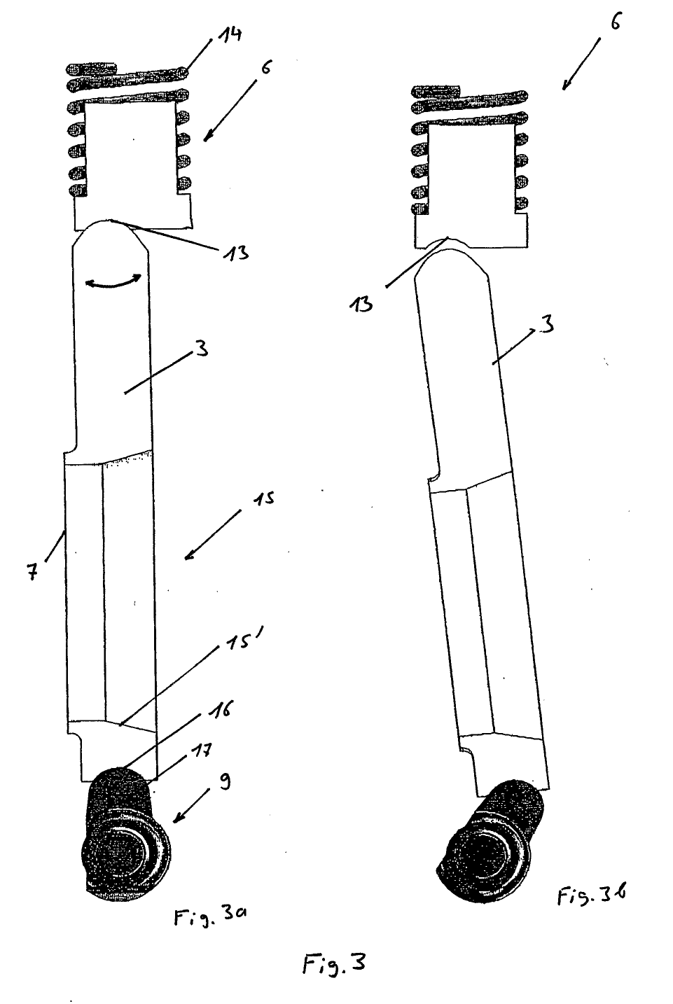

FIG. 3 depicts a third embodiment of the device according to the invention.

FIG. 1 depicts an embodiment of the device according to the invention. A piece of foodstuff 2 is the blade 4 acts together with the cutting edge 7 of the cutting strip 3 in the form of a counter-blade. The blade 4 and the cutting edge 7 define the cutting plane 11. Present between the blade 4 and the cutting edge 7 is the cutting gap 5. A person skilled in the art will appreciate that the cutting gap can be zero, at least in the lower area. The cutting strip 3 is supported in such a way as to be capable of pivoting at the pivot point 6, which is executed here as a pivot axis 8 and a bearing 12, in conjunction with which the pivoting is effected by the eccentric 9, of which the spigot 9′ is partially accommodated in the recess 10 with positive engagement. The directions of pivoting are symbolized by the double arrow. The cutting gap 5 is set with the pivoting, in conjunction with which pivoting in the clockwise direction reduces the cutting gap, and pivoting in the anticlockwise direction increases the cutting gap. The cutting strip 7 is capable of displacement along the axis of pivoting 8 in and out of the plane of the paper. By means of this displacement, account can be taken of pieces of foodstuff of different diameters and with different positions. The cutting strip is part of a mouth piece; that is to say, the cutting strip in the present case at least partially comprises the contour of the piece of foodstuff, so that the piece of foodstuff 2 is supported not only downwards, but also laterally during cutting.

FIG. 2 depicts the device according to the invention as depicted in FIG. 1, although in this case the spigot 9′ of the eccentric is arranged with a larger recess 10. As a result, the spigot 9′ makes contact only on one side of the recess. Furthermore, the device according to the invention exhibits a pivot spring (not illustrated), which pretensions the cutting strip against the bolt 9 in the clockwise direction. A particular preference exists for the blade to contact the cutting edge in this case on each passage of the blade and in so doing to deflect the cutting strip lightly against the pretension.

Through this embodiment, the cutting edge, which in conjunction with the cutting blade forms the cutting gap, is displaced to a minimal extent from its basic position on each passage of the blade, in conjunction with which the size of this displacement is in the order of less than one tenth of a millimeter.

FIG. 3a depicts a further embodiment of the device according to the invention. In the present case, the cutting strip 3 is mounted in its upper area with positive engagement in such a way as to be capable of pivoting in a bearing recess 13, as indicated by the double arrow. The bearing recess 13 is pretensioned against the cutting strip 3 by means of the spring 14. In its lower area, the cutting strip 3 exhibits an indentation 16, which interacts with positive engagement with a cam 17 of the pivot means. As soon as this pivot means 9 is caused to pivot in the clockwise or anticlockwise direction, the cutting strip 3 pivots inside the bearing recess 13, as a consequence of which the cutting gap between the cutting edge 7 and the blade (not illustrated), is adjusted accordingly. This adjustment can be achieved by a pivoting movement of the pivot means 9, which comprises a few degrees. The cutting strip 3 exhibits an opening 15 with a funnel-shaped inlet incline 15′, into which and through which the piece of foodstuff to be sliced is passed. The opening corresponds essentially to the periphery of the piece of foodstuff, so that the cutting pressure of the blade on the product is applied not only in a downward direction, but also laterally. The fact that the piece of foodstuff is guided in the opening 15 means that it can be varied in its position parallel to the axis of pivoting of the cutting strip by the displacement of the cutting strip 3 along its axis of pivoting, that is to say into or from the plane of the paper.

FIG. 3b depicts the device according to the invention as depicted in FIG. 3a, although in the present case the cam 17 of the pivot means 9 has been caused to pivot through about 45° in the clockwise direction. This pivoting results in a comparatively large vertical displacement of the cutting strip. Since the spring travel of the spring 14 is limited, the positive engagement between the cutting strip 3 and the bearing recess 13 is released, and the cutting strip 3 can thus be removed in a very simple manner.

### LIST OF REFERENCE DESIGNATIONS

1 device
2 foodstuff
3 cutting strip
4 blade
5 cutting gap
6 pivot point
7 cutting edge
8 pivot axis
9 pivot means
9′ spigot
10 recess in the cutting strip
11 cutting plane
12 divided bearing
13 bearing recess
14 spring
15 opening for the piece of foodstuff
15′ funnel-shaped opening
16 indentation
17 cam

1-20. (canceled)

21. A device for slicing food, comprising:
a machine housing with a product feed unit attached thereto,
a cutting strip arranged at the end of the product feed unit, the cutting strip having a cutting edge and a pivot point; and
a blade, the cutting strip and the blade defining a cutting gap.

22. The device of claim 21, wherein the cutting strip is configured to pivot and/or flex at least partially about the pivot point for the purpose of adjusting the cutting gap.

23. The device of claim 21, wherein the pivot point is arranged above the cutting edge.

24. The device of claim 21, wherein the pivot point is arranged as close as possible to the blade.

25. The device of claim 21, wherein the pivot point is a pivot bearing.

26. The device of claim 21, wherein the cutting strip is capable of displacement in a direction substantially parallel to the pivot axis of the cutting strip.

27. The device of claim 21, wherein the cutting strip is pretensioned at least partially in the direction of the blade with a spring.

28. The device of claim 27, wherein the speed of movement of the cutting strip in the direction of the blade is limited by means of a damping element.

29. The device of claim 27, wherein the cutting edge touches the blade at least partially on each passage of the blade.

30. The device of claim 21, further comprising a mechanism interacting with the cutting strip to adjust the cutting gap.

31. The device of claim 30, wherein the mechanism is arranged at a distance from the pivot point.

32. The device of claim 30, wherein the mechanism is an eccentric.

33. The device of claim 21, wherein the cutting gap is adjusted automatically or manually.

34. The device of claim 33, wherein adjustment is effected via a regulated drive.

35. The device of claim 33, wherein adjustment takes place before or during operation of the device.

36. The device of claim 21, wherein the pivot point comprises a bearing recess configured to receive an end of the cutting strip.

37. The device of claim 21, wherein the cutting strip is configured to be moved to adjust the cutting gap and the movement can also be utilized to release or to secure the cutting strip.

38. The device of claim 37, wherein the movement is a rotational movement.

39. The device of claim 37, wherein the distance covered in conjunction with the movement to release or secure the cutting strip is greater than in conjunction with the adjustment of the cutting gap.

40. A method for the adjustment of the cutting gap between the blade and the cutting edge of a cutting strip in a food slicing machine, comprising:
providing a cutting strip configured to pivot and/or flex at least partially about a pivot point; and
pivoting and/or flexing the cutting strip about the pivot point to adjust the cutting gap.
